(19) United States
(12) Patent Application Publication
(10) Pub. No.: US 2025/0202709 A1
(43) Pub. Date: Jun. 19, 2025

(54) MANAGEMENT DEVICE, MANAGEMENT METHOD, AND MANAGEMENT PROGRAM

(71) Applicant: SONY GROUP CORPORATION, TOKYO (JP)

(72) Inventor: TAIZO SHIRAI, TOKYO (JP)

(21) Appl. No.: 18/849,527

(22) PCT Filed: Mar. 20, 2023
(86) PCT No.: PCT/JP2023/010825

§ 371 Date: Sep. 22, 2024

(30) Foreign Application Priority Data
Mar. 30, 2022 (JP) 2022-055056

(51) Int. Cl. H04L 9/32; H04L 9/08

(52) U.S. Cl. CPC H04L 9/3231; H04L 9/0819; H04L 9/3247

(57) ABSTRACT

A management device (100) according to an aspect of the present disclosure includes: a communication control unit (133) that sets up a session between a first device and a second device; a transfer unit (134) that, upon acquisition of a first authentication result indicating that authentication of an identity of a user has been executed in the first device, transfers, to the second device, authentication information used in authentication processing in the first device; and a duplication unit (135) that, upon acquisition of a second authentication result indicating that the authentication of the identity of the user has been executed by the second device using the transferred authentication information, duplicates key information corresponding to the first authentication result and stored in the first device to the second device.

### FIELD

The present disclosure relates to a management device, a management method, and a management program that manage key information for use in authentication.

### BACKGROUND

In recent years, with the spread of communication networks, services via communication networks have been actively provided. When using such a service, a user may be required to certify his/her identity by various types of authentication processing. For example, a user performs authentication in order to certify that the user himself/herself truly takes an action, such as when logging in to a service, transmitting and receiving a transaction indicating a dealing or the like in a blockchain technique, or dealing in a metaverse space.

As an example of an authentication method, there has been proposed a method such as Fast Identity Online Alliance (FIDO) in which in order to enhance safety, biometric authentication or the like is performed on a terminal side of a user and only information obtained by signing an authentication result with a secret key is transmitted, instead of transmitting correct answer data or collation template data itself for use in collation to a service side. Regarding such an authentication method, there has been proposed a technique for guaranteeing an authentication strength even when a terminal device is changed (e.g., Patent Literature 1). In addition, a technique of account recovery with enhanced convenience in an authentication method such as FIDO has been proposed (e.g., Patent Literature 2).

### CITATION LIST

### Patent Literature

Patent Literature 1: JP 2021-150681 A

Patent Literature 2: JP 2021-047814 A

### SUMMARY

### Technical Problem

According to the related art, even when a terminal of a user is changed or lost, the user can use the same authentication means or the same service as before.

On the other hand, a user has a need for so-called backup in which instead of coping after a terminal is changed or lost, key information held in a terminal is held in another terminal in advance in preparation for such an unexpected situation. Some of authentication methods and terminal configurations allow information for returning key information to be written on paper. However, such a manner increases a burden on a user, such as management of a paper medium or manual input at the time of backup.

Therefore, the present disclosure proposes a management device, a management method, and a management program that easily realize secure management of a key while maintaining security.

### Solution to Problem

A management device according to one embodiment of the present disclosure includes: a communication control unit that sets up a session between a first device and a second device; a transfer unit that, upon acquisition of a first authentication result indicating that authentication of an identity of a user has been executed by the first device, transfers, to the second device, authentication information used in authentication processing in the first device; and a duplication unit that, upon acquisition of a second authentication result indicating that authentication of the identity of the user has been executed by the second device using the transferred authentication information, duplicates key information corresponding to the first authentication result and stored in the first device to the second device.

### BRIEF DESCRIPTION OF DRAWINGS

FIG. 1 is a diagram illustrating an overview of management processing according to an embodiment.

FIG. 2 is a diagram schematically illustrating a flow of the management processing according to the embodiment.

FIG. 3 is a diagram illustrating a configuration example of a management device according to the embodiment.

FIG. 4 is a diagram illustrating an example of a data table according to the embodiment.

FIG. 5 is a diagram (1) schematically illustrating a flow of duplication processing according to the embodiment.

FIG. 6 is a diagram (2) schematically illustrating a flow of the duplication processing according to the embodiment.

FIG. 7 is a flowchart illustrating a flow of processing according to the embodiment.

FIG. 8 is a diagram illustrating an example of a data table according to a modification.

FIG. 9 is a hardware configuration diagram illustrating an example of a computer that implements functions of the management device.

### DESCRIPTION OF EMBODIMENTS

In the following, embodiments will be described in detail with reference to the drawings. In each of the following embodiments, the same parts are denoted by the same reference numerals to omit redundant description.

The present disclosure will be described according to the following order of items.
1. Embodiment
1-1. Overview of Management Processing according to Embodiment
1-2. Configuration of Management Device according to Embodiment
1-3. Procedure of Processing according to Embodiment
1-4. Modification
1-4-1. Verification Processing for Verifying That Duplication Terminal is Present Nearby
1-4-2. Storage of Duplication Trace
1-4-3. Detection of Authentication Means
2. Other Embodiments
3. Effects of Management Device according to Present Disclosure
4. Hardware Configuration

### 1. Embodiment

### 1-1. Overview of Management Processing According to Embodiment

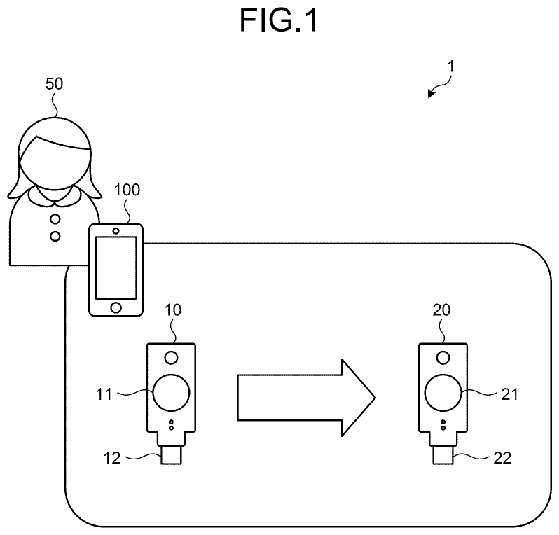

An example of management processing according to an embodiment will be described with reference to FIG. 1. FIG. 1 is a diagram illustrating an overview of the management processing according to the embodiment. FIG. 1 illustrates components of a management system 1 that executes the management processing according to the embodiment.

The management system 1 includes a management device 100, a first device 10, and a second device 20.

The management device 100 is an example of an information processing device that executes the management processing according to the embodiment. In the embodiment, the management device 100 is a terminal device owned by a user 50, and is, for example, a smartphone, a personal computer (PC), or the like. The management device 100 can communicate with external devices such as the first device 10 and the second device 20 via a network.

The first device 10 is an example of an authentication device according to the embodiment, and is a terminal serving as a backup source of key information in duplication processing according to the embodiment. The authentication device is a device capable of certifying an identity of a user by performing authentication processing using an authenticator.

For example, the first device 10 acquires fingerprint information of a user to be authenticated using a fingerprint authentication sensor 11. Then, the first device 10 extracts feature information (generally referred to as a “template”) from the acquired fingerprint information, and registers the extracted feature information in a storage unit (internal memory). In the authentication processing, the first device 10 acquires the fingerprint information for collation from the fingerprint authentication sensor 11 which the user' finger touches, and collates the acquired information with the registered feature information to determine whether or not the user who has attempted the authentication matches a user of the registered feature information.

In the embodiment, the first device 10 is, for example, a FIDO compatible terminal for use in a FIDO method, a hardware wallet that is a storage device of encrypted assets, or the like. Specifically, the first device 10 is connected to a terminal (such as a PC) that uses a service via a network through a communication terminal 12. Then, the first device 10 is used for the user 50 to perform the authentication processing when using such a service. When the authentication processing of the user 50 succeeds, the first device 10 signs an authentication result with a secret key held in the first device 10, and transmits signature information to a server or the like on a service side. The service side decodes the signature with a public key paired with the secret key to confirm that the authentication result has not been tampered. As a result, the service side can confirm the identity of the accessing user as the user 50.

Specifically, since the user 50 can perform authentication without transmitting authentication information itself (i.e., correct answer data in authentication) such as the fingerprint information to the outside by using the first device 10 storing the secret key for signature generation, authentication with high safety can be performed. Such authentication based on a public key digital signature scheme, which is a form of a so-called public key encryption scheme, is widely used in the use of a service on a network, in the fields of online payment, and the like.

Similarly to the first device 10, the second device 20 is an example of the authentication device according to the embodiment, and is a terminal serving as a backup destination of the key information in the duplication processing according to the embodiment. In the embodiment, the second device 20 has the same functional configuration as that of the first device, and includes a fingerprint authentication sensor 21 and the communication terminal 22. Specifically, in the example of FIG. 1, a terminal prepared by the user 50 to back up (duplicate) the key information held in the first device 10 is the second device 20.

For example, the user 50 desires the second device 20 to duplicate the key information of the first device 10 in advance in preparation for an unexpected situation in which the first device 10 is lost or the key information is lost from the first device 10. Since the key information is secret information, it is desirable that the key information is managed so as not to be easily duplicated. For this reason, for example, in the FIDO method, a backup means is proposed in which a user prepares two authentication devices and registers the two authentication devices for authentication. However, such means prepares two different pieces of key information for backup, and cannot duplicate currently used key information to another terminal.

In addition, for some of authentication methods or authentication devices, there is also provided a means enabling writing of key information to a paper or the like in preparation for a loss of a key, or enabling return of the key information by inputting specific information. However, such means takes time and effort to manage a paper medium and manually input specific information, and there therefore remains a problem in terms of security and quick recovery.

Therefore, the management device 100 according to the embodiment solves the above problem by processing to be described below. For example, the management device 100 sets up a secure session between the first device 10 as a backup source and the second device 20 as a backup destination. Then, when acquiring a first authentication result indicating that the first device 10 has executed authentication of an identity of the user 50, the management device 100 transfers authentication information (e.g., a fingerprint template) used in the authentication processing in the first device 10 to the second device 20. Subsequently, when acquiring a second authentication result indicating that the second device 20 has executed the authentication of the identity of the user 50 using the transferred authentication information, the management device 100 duplicates key information corresponding to the first authentication result and stored in the first device 10 to the second device 20.

In this manner, the management device 100 ensures safety by causing the authentication devices to directly communicate with each other in a secure session, transmits the authentication information for use in the authentication by the first device 10 to the second device 20, and then causes the second device 20 to execute the authentication processing. As a result, the management device 100 can reliably determine that a user who holds the first device 10 and a user who holds the second device 20 are the same person (the user 50 in this example). Through such processing, the management device 100 duplicates the key information including the secret key for signature generation held in the first device 10 to the second device 20. Therefore, the management device 100 can quickly and easily duplicate the key information while maintaining safety. Note that the key information according to the embodiment may include not only a secret key for a signature but also a public key to be paired with the secret key.

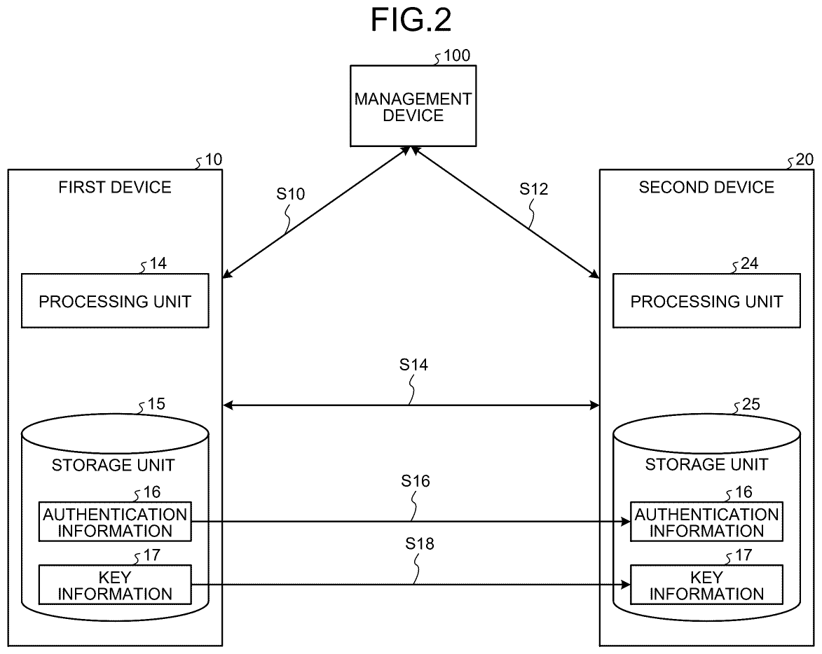

The management processing according to the embodiment will be described in more detail with reference to FIG. 2. FIG. 2 is a diagram schematically illustrating a flow of the management processing according to the embodiment.

In the embodiment, the management device 100 controls the first device 10 and the second device 20, and functions as a control device that instructs on processing such as duplication of key information. For example, the management device 100 executes processing to be described below by operating a control application for executing the management processing according to the embodiment. Note that the user 50 appropriately gives an instruction to the management device 100 via the control application to progress backup of the key information.

First, the user 50 who desires duplication of the key information from the first device 10 to the second device 20 disposes the first device 10 and the second device 20 in the vicinity of the management device 100 and commands the management device 100 to execute duplication.

Upon receiving such a command, the management device 100 searches for a nearby terminal using a predetermined communication means. Then, the management device 100 detects the first device 10 and sets up communication with the first device 10 (Step S10). In addition, the management device 100 detects the second device 20 and sets up communication with the second device 20 (Step S12).

When confirming that the first device 10 and the second device 20 have been searched for by the management device 100, the user 50 designates a backup source terminal and a backup destination terminal. In the embodiment, the user 50 designates the first device 10 as a backup source and designates the second device 20 as a backup destination.

Upon receiving the designation by the user 50, the management device 100 instructs the first device 10 and the second device 20 to start preparation for backup processing. First, the management device 100 sets up a secure session between the first device 10 and the second device 20 (Step S14). Various known techniques may be used for such session set-up. Specifically, the management device 100 sets up a session for performing communication using a protocol (e.g., an encryption protocol such as Diffie-Hellman key sharing) enabling secure transmission and reception of key information to be described later.

Subsequently, the management device 100 instructs the first device 10 and the second device 20 to start the backup processing. Specifically, the management device 100 instructs the first device 10 to perform biometric authentication of the user 50. For example, the management device 100 displays the control application to instruct the user 50 to perform fingerprint authentication with the first device 10. In accordance with such an instruction, the user 50 places his/her finger on the fingerprint authentication sensor 11 of the first device 10 and starts authentication.

When acquiring the fingerprint information of the user 50, a processing unit 14 related to the first device 10 collates the fingerprint information with authentication information 16 that is a fingerprint template registered in a storage unit 15, and authenticates the user 50 as the authentic person. Then, the processing unit 14 adds a signature to this authentication result using key information 17 of the storage unit 15. The management device 100 acquires an authentication result (referred to as a “first authentication result” for distinction) indicating that the first device 10 confirms the identity of the user 50. Note that it is not necessary for the management device 100 to actually acquire the signature information as long as it can be confirmed that the first device 10 has executed authentication without any problem.

When the first device 10 confirms the identity of the user 50, the management device 100 performs control to transfer the authentication information 16 from the first device 10 to the second device 20 (Step S16). As described above, such transfer is executed via a secure session.

When acquiring the authentication information 16, a processing unit 24 related to the second device 20 confirms that the authentication information 16 has not been tampered in the transfer, and then stores the authentication information in a storage unit 25 of the own device.

Subsequently, the management device 100 instructs the second device 20 to perform biometric authentication of the user 50. For example, the management device 100 displays the control application to instruct the user 50 to perform fingerprint authentication with the second device 20. In accordance with such an instruction, the user 50 places his/her finger on the fingerprint authentication sensor 21 of the second device 20 and starts authentication.

When acquiring the fingerprint information of the user 50, the processing unit 24 related to the second device 20 collates the fingerprint information with the authentication information 16 that is a fingerprint template registered in the storage unit 25, and authenticates the user 50 as the authentic person. When the authentication of the identity succeeds, the second device 20 transmits an authentication result (referred to as a “second authentication result” for distinction) to the management device 100 and the first device 10. As a result, the management device 100 and the first device 10 can confirm that the authentication has been performed without any problem by the authentication information 16 transferred to the second device 20, i.e., that the first device 10 and the second device 20 are certainly used by the user 50 who is the same user.

When this confirmation is made, the management device 100 performs control to duplicate the key information 17 held by the first device 10 to the second device 20 (Step S18). As described above, such duplication is executed via a secure session. Specifically, the first device 10 transmits information of the secret key and the public key protected by the protocol to the second device 20.

When acquiring the protected secret key and public key, the second device 20 confirms that these keys have not been tampered, and then stores the keys in the storage unit 25 of the own device. After storing the key information 17 in the storage unit 25 without any problem, the second device 20 notifies the management device 100 of the completion of the processing.

Upon receiving a processing completion notification from the second device 20, the management device 100 controls the first device 10 and the second device 20 to end the backup processing. In addition, the management device 100 displays successful completion of the processing on the control application, and notifies the user 50 to that effect.

As described in the foregoing with reference to FIGS. 1 and 2, the management device 100 authenticates that both devices are definitely owned by the user 50, and then duplicates the key information using the secure session. Since this enables the user 50 to attach a signature also in the second device 20 using the key information 17 held in the first device 10, service used so far can be continuously used without any trouble. In addition, since according to the management processing according to the embodiment, the authentication information 16 held in the first device 10 is also transferred to the second device 20, the user 50 can use the second device 20 in the same manner as the first device 10 without newly generating authentication information such as a fingerprint template. As described in the foregoing, the management device 100 according to the embodiment easily and safely realizes management of a key while maintaining security.

Furthermore, each device in FIG. 1 conceptually illustrates a function in the management system 1, and various modes can be taken according to the embodiment. For example, the management device 100 may include two or more devices different for each function to be described later.

### 1-2. Configuration of Management Device According to Embodiment

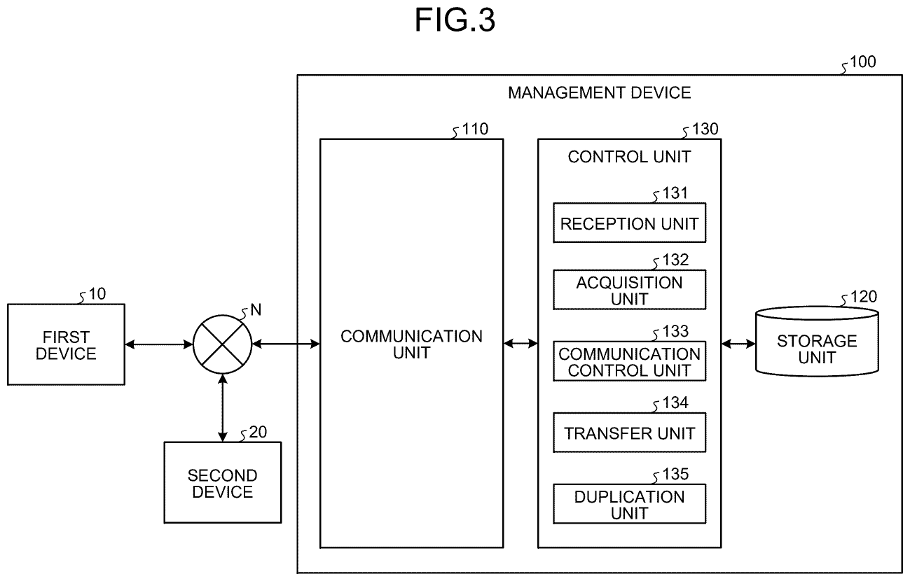

Next, a configuration of the management device 100 will be described. FIG. 3 is a diagram illustrating a configuration example of the management device 100 according to the embodiment.

As illustrated in FIG. 3, the management device 100 includes a communication unit 110, a storage unit 120, and a control unit 130. Note that the management device 100 may have an input unit (e.g., a touch panel, a keyboard, or the like) that receives various operations from a user or the like who uses the management device 100, and a display unit (e.g., a liquid crystal display or the like) for displaying various types of information.

The communication unit 110 is realized by, for example, a network interface card (NIC), a network interface controller, or the like. The communication unit 110 is connected to a network N in a wired or wireless manner, and transmits and receives information to and from the first device 10, the second device 20, and the like via the network N. The network N is realized by, for example, a wireless communication standard or system such as Bluetooth (registered trademark), the Internet, Wi-Fi (registered trademark), ultra wide band (UWB), and low power wide area (LPWA).

The storage unit 120 is realized by, for example, a semiconductor memory element such as a random access memory (RAM) or a flash memory, or a storage device such as a hard disk or an optical disk.

The storage unit 120 stores various types of information regarding the management processing according to the embodiment. For example, the storage unit 120 stores information required for information processing executed by the control unit 130 to be described later.

The control unit 130 is realized by, for example, a central processing unit (CPU), a micro processing unit (MPU), GPU, or the like executing a program (e.g., a management program according to the present disclosure) stored in the management device 100 using a random access memory (RAM) or the like as a work area. Furthermore, the control unit 130 is a controller, and may be realized by, for example, an integrated circuit such as an application specific integrated circuit (ASIC) or a field programmable gate array (FPGA).

As illustrated in FIG. 3, the control unit 130 includes a reception unit 131, an acquisition unit 132, a communication control unit 133, a transfer unit 134, and a duplication unit 135.

The reception unit 131 receives various requests. For example, the reception unit 131 receives a request for the backup processing of key information from the user.

The acquisition unit 132 acquires various types of information. For example, when the reception unit 131 receives the request for the backup processing of the key information from the user, the acquisition unit 132 searches for a terminal present in the vicinity of the management device 100. Then, the acquisition unit 132 acquires information of the searched terminal. For example, the acquisition unit 132 acquires device information such as identifiers of the first device 10 and the second device 20 which are the searched terminals. In addition, the acquisition unit 132 acquires the first authentication result indicating that the first device 10 has succeeded in authentication of the user, the second authentication result indicating that the second device 20 succeeds in authentication of the user, and the like.

The communication control unit 133 controls communication with the first device 10 and the second device 20. For example, the communication control unit 133 specifies the first device 10 and the second device 20 on the basis of the device information acquired by the acquisition unit 132, and sets up a secure session between the specified two terminals. Various known techniques may be used to set up such a session.

When acquiring the first authentication result indicating that the first device 10 has executed the authentication of the identity of the user, the transfer unit 134 transfers the authentication information used in the authentication processing in the first device 10 to the second device 20.

Specifically, the transfer unit 134 acquires, as the first authentication result, signature information that is a signature certifying that the authentication processing of the user has been executed by the first device 10 and that is a signature using the key information. The signature information is, for example, a hash value or the like that can be decoded with a public key paired with a secret key.

The authentication information is information for use in authenticating an identity of the user, and corresponds to various types of information according to authentication means. As an example, the transfer unit 134 transfers biological information of the user to the second device 20 as the authentication information. Note that the biological information is not necessarily limited to information acquired from a body of the user, and may include various types of information acquired in the process of a user's activity, such as a user's behavior, which can be used to specify the user.

Specifically, as the biological information of the user, the transfer unit 134 transfers, to the second device 20, feature information generated from at least one of the fingerprint information, face information, vein information, iris information, voiceprint information, palm print information, handwriting information, and personal behavior information of the user. For example, when acquiring the first authentication result by collation of the fingerprint information of the user using the fingerprint authentication sensor 11 included in the first device 10, the transfer unit 134 transfers the feature information of the fingerprint information of the user used in the collation in the first device 10 to the second device 20.

Note that instead of the feature information, the transfer unit 134 may transfer material information, which is information for generating the feature information, from the first device 10 to the second device 20. Specifically, as the biological information of the user, the transfer unit 134 transfers the material information for generating feature information of at least one of the fingerprint information, the face information, the vein information, the iris information, the voiceprint information, the palm print information, the handwriting information, and the personal behavior information of the user to the second device 20.

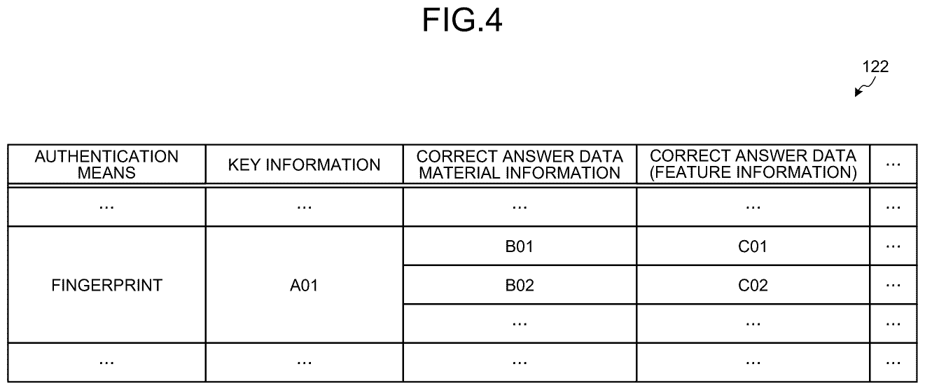

The above processing will be described with reference to FIG. 4. FIG. 4 is a diagram illustrating an example of a data table 122 according to the embodiment. The data table 122 illustrates an example of the authentication information held in the first device 10.

In the example illustrated in FIG. 4, the data table 122 has items such as “authentication means”, “key information”, “correct answer data material information”, and “correct answer data (feature information)”. Although in the example illustrated in FIG. 4, information stored in the item is conceptually shown as “A01”, specific information to be described later is stored in each item in practice.

The “authentication means” indicates a means or a method for authenticating a user. The example of FIG. 4 shows that the authentication means is a “fingerprint”. The “key information” indicates a key for generating a signature to be attached to an authentication result when the user is authenticated. The “correct answer data material information” indicates information serving as a base for generating feature information which is correct answer data of authentication. The “correct answer data (feature information)” is correct answer data to be collated with information input from the user at the time of authentication, and indicates feature information on the basis of which the material information is generated. As illustrated in FIG. 4, there may be a plurality of pieces of correct answer data of authentication. For example, by registering fingerprints of a plurality of fingers as correct answer data, the user can properly use his/her finger to be used for authentication according to a situation.

As described in the foregoing, when the material information for generating the feature information is held in the first device 10, the management device 100 can transfer the material information, instead of the feature information, from the first device 10 to the second device 20. In the example of FIG. 4, the material information corresponds not to the fingerprint template but to a plurality of pieces of image information serving as a base for generating the fingerprint template. As a result, even when the first device 10 and the second device 20 include different authenticators, a new fingerprint template can be generated in the second device 20, so that the user can save time and effort to register a fingerprint in the second device 20. Specifically, even when the first device 10 and the second device 20 are not manufactured by the same manufacturer and the same template cannot be used due to different authentication engines, the management device 100 can solve such a problem by transferring a material itself of the template. Note that the management device 100 may transfer not an image held for template generation but an image of a fingerprint acquired at the time of authentication of the first device 10 to the second device 20. At this time, in a case where an image acquired by one authentication is insufficient for template generation, the management device 100 may cause the user to execute authentication a plurality of times and to transfer a plurality of images acquired by the authentication executed the plurality of times. When information other than a fingerprint is used for authentication, the management device 100 may appropriately store feature information and material information as the information for use in authentication in the data table 122. For example, the management device 100 stores user's face image, vein image, iris image, and voiceprint and palm print information in the data table 122. In addition, the management device 100 stores feature information extracted from handwriting of the user and a handwriting image in the data table 122. In addition, the management device 100 stores, in the data table 122, various behavior histories corresponding to behaviors of an individual, such as behavior analysis information in terminal operation by the user, feature information generated on the basis of the behavior history, and the like.

Returning to FIG. 3, the description will be continued. The transfer unit 134 may transfer not the biological information but different information as the authentication information. For example, as the authentication information, the transfer unit 134 may transfer character string information registered in advance by the user for the authentication processing to the second device 20. The character string information is, for example, a password registered by the user or a personal identification number code (PIN code) for use to unlock the terminal.

Alternatively, as the authentication information, the transfer unit 134 may transfer an identifier of a third device that is capable of non-contact communication and is registered in advance by the user for the authentication processing to the second device. The third device capable of non-contact communication is, for example, an IC card or the like on which a non-contact communication technique is mounted such as FeliCa (registered trademark). As the authentication means, there is a method in which holding of an IC card by a user is used to certify that the user owns the IC cared as proof of an identity. In this case, in a case of detecting communication with the IC card, the first device 10 reads an identifier of the IC card, and determines whether or not the identifier is registered in advance, thereby authenticating the user. Instead of the identifier, key information associated in the IC card may be used.

When acquiring the second authentication result indicating that the second device 20 has executed the authentication of the identity of the user using the transferred authentication information, the duplication unit 135 duplicates key information corresponding to the first authentication result and stored in the first device 10 to the second device 20.

For example, when acquiring the second authentication result by collation in which transferred feature information is used as the correct answer data and which is collation of the fingerprint information of the user using the fingerprint authentication sensor 21 included in the second device 20, the duplication unit 135 duplicates the key information stored in the first device 10 to the second device 20.

In other words, as illustrated in FIG. 2, the duplication unit 135 controls the first device 10 so as to transmit the key information held in the first device 10 to the second device 20. Furthermore, after confirming, in the second device 20, that the transmitted key information has not been tampered, the duplication unit 135 performs control to store the key information in the storage unit of the second device 20. As a result, the duplication unit 135 can duplicate the key information from the first device 10 to the second device 20.

After duplicating the key information to the second device 20, the duplication unit 135 may cause the second device 20 to execute authentication processing for certifying that the duplicated key information is available. For example, the duplication unit 135 instructs the user to perform the authentication processing with the second device 20. Then, when the user performs authentication, the second device 20 adds a signature to an authentication result with the key information received from the first device 10. The management device 100 transmits the signature to a predetermined service that has performed authentication using the first device 10, and checks whether or not the authentication is successfully completed in the service. At this time, in a case where some kind of trouble has occurred in the duplication processing (e.g., in a case where some kind of error has occurred in the duplication and the key information has been rewritten), the authentication becomes an error, and thus, on the basis of such a result, the management device 100 can check whether or not the duplication processing has been successfully completed. Note that the duplication unit 135 may delete the key information held by the first device 10 after confirming that the duplication of the key information to the second device 20 has been successfully completed in accordance with a request from the user, an authentication policy of the service, or the like.

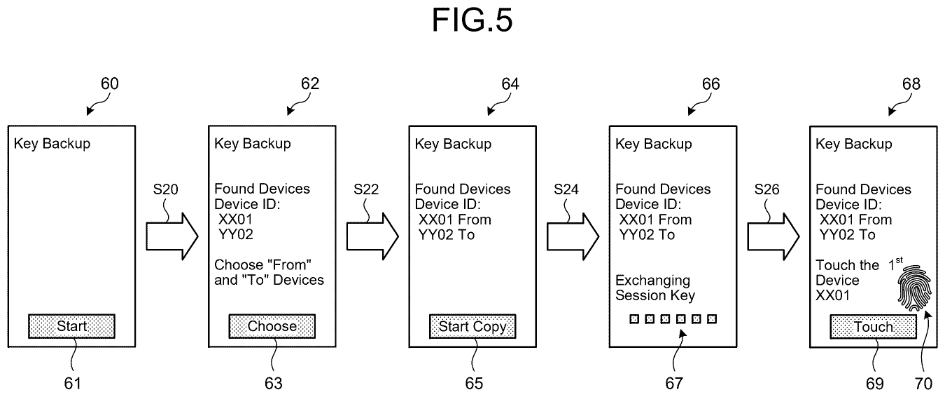

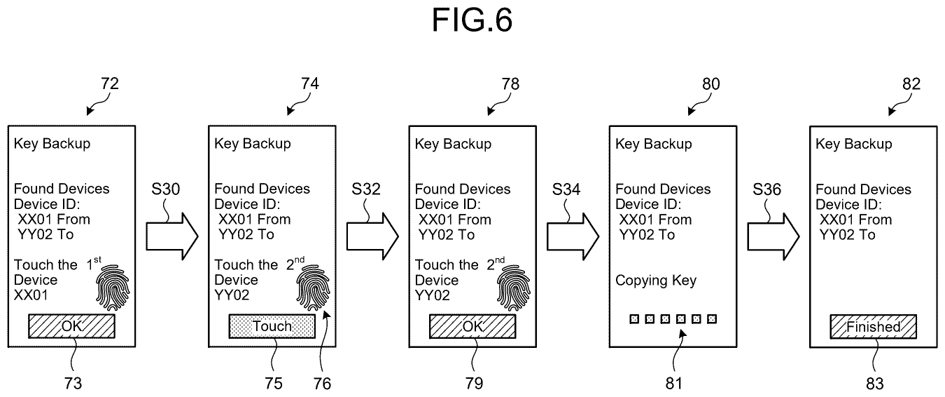

The duplication processing to be executed by the control unit 130 is executed, for example, on the control application installed in the management device 100. The user can duplicate the key information by appropriately inputting information or performing authentication according to an instruction of the control application. An operation example of the control application will be described with reference to FIGS. 5 and 6.

FIG. 5 is a diagram (1) schematically illustrating a flow of the duplication processing according to the embodiment. FIG. 5 illustrates an example of a display screen of the management device 100 on which the control application operates.

When the control application is activated, the management device 100 displays a screen 60 illustrated in FIG. 5. The screen 60 includes a start button 61 for a user to request start of backup. When the user presses the start button 61, the management device 100 causes the screen 60 to make a transition to a screen 62 (Step S20).

The screen 62 includes a terminal name (identifier) searched by the management device 100 on the basis of a surrounding communication condition or the like. The example of FIG. 5 indicates that the management device 100 has searched for terminals identified by an identifier “XX01” and an identifier “YY02”. For example, the identifier “XX01” represents the first device 10, and the identifier “YY02” represents the second device 20. When the searched terminal is not wrong, the user presses a selection button 63. When the user presses the selection button 63, the management device 100 causes the screen 62 to make a transition to a screen 64 (Step S22).

The screen 64 shows a backup source terminal and a backup destination terminal of the key information. If the backup source terminal and the backup destination terminal are not wrong, the user presses a backup start button 65. When the user presses the backup start button 65, the management device 100 causes the screen 64 to make a transition to a screen 66 (Step S24).

The screen 66 displays information indicating that the management device 100 is setting up a secure session between the backup source and the backup destination. When the set-up of the session is completed, the management device 100 causes the screen 66 to make a transition to a screen 68 (Step S26).

The screen 68 displays that the management device 100 instructs the user to perform the authentication processing in the first device 10. For example, the management device 100 prompts the user to perform the authentication processing by blinking a confirmation display 69 on the screen 68 or displaying a fingerprint display 70 on the screen 68.

A screen display subsequent to FIG. 5 is shown in FIG. 6. FIG. 6 is a diagram (2) schematically illustrating a flow of the duplication processing according to the embodiment.

When the user performs the authentication processing with the first device 10, the management device 100 causes the screen 68 illustrated in FIG. 5 to make a transition to a screen 72. On the screen 72, the management device 100 changes the confirmation display 69 of the screen 68 to a progress button 73 to suggest to the user that the authentication in the first device 10 is completed. When the user presses the progress button 73, the management device 100 causes the screen 72 to make a transition to a screen 74 (Step S30). At this time, the management device 100 transfers the authentication information (fingerprint template) from the first device 10 to the second device 20.

The screen 74 displays that the management device 100 instructs the user to perform the authentication processing in the second device 20. For example, the management device 100 prompts the user to perform the authentication processing by blinking a confirmation display 75 on the screen 74 or displaying a fingerprint display 76 on the screen 74. When the user performs the authentication processing with the second device 20, the management device 100 causes the screen 74 to make a transition to a screen 78 (Step S32).

On the screen 78, the management device 100 changes the confirmation display 75 of the screen 74 to a progress button 79 to suggest to the user that the authentication in the second device 20 is completed. When the user presses the progress button 79, the management device 100 causes the screen 78 to make a transition to a screen 80 (Step S34).

The screen 80 displays information indicating that the management device 100 is duplicating the key information from the backup source to the backup destination. When the duplication is completed, the management device 100 causes the screen 80 to make a transition to a screen 82 (Step S36).

The screen 82 displays that the management device 100 has completed the duplication of the key information. When the user presses a completion button 83, the management device 100 causes the duplication processing to be completed and ends the operation of the control application.

### 1-3. Procedure of Processing According to Embodiment

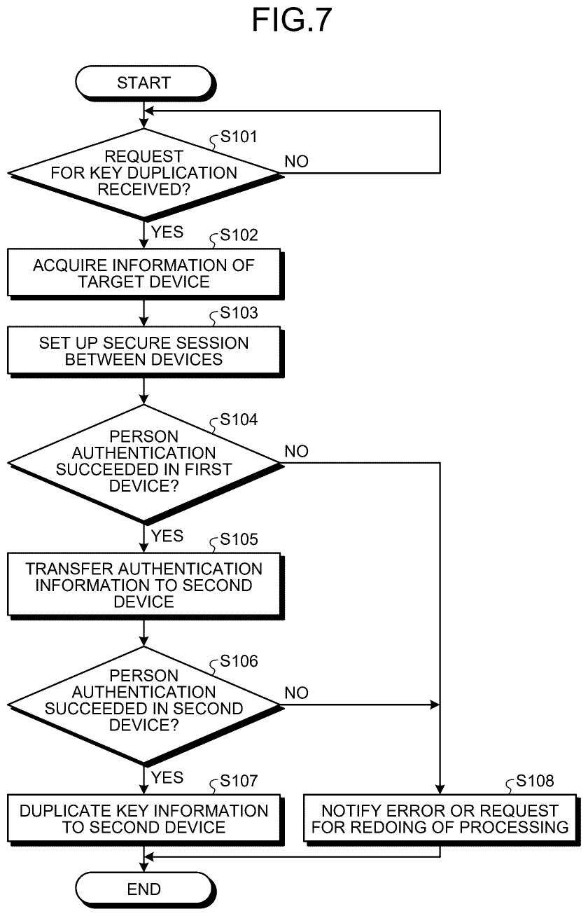

Next, a procedure of the processing according to the embodiment will be described with reference to FIG. 7. FIG. 7 is a flowchart illustrating a flow of the processing according to the embodiment.

As illustrated in FIG. 7, the management device 100 determines whether or not a request for key duplication has been received from the user (Step S101). In a case where the request has not been received (Step S101; No), the management device 100 waits until the request is received.

On the other hand, in a case where the request for key duplication has been received (Step S101; Yes), the management device 100 acquires device information by searching for a device to be duplicated (Step S102). Thereafter, the management device 100 sets up a secure session between devices to be duplicated (Step S103).

Subsequently, the management device 100 determines whether or not the person authentication has succeeded in the first device 10 (Step S104). When the authentication has succeeded (Step S104; Yes), the management device 100 transfers the authentication information used for the authentication to the second device 20 (Step S105).

Subsequently, the management device 100 determines whether or not the person authentication has succeeded in the second device 20 (Step S106). When the authentication has succeeded (Step S106; Yes), the management device 100 duplicates the key information from the first device 10 to the second device 20 (Step S107).

On the other hand, when the person authentication does not succeed in the first device 10 (Step S104; No) or when the person authentication does not succeed in the second device 20 (Step S106; No), the management device 100 determines that the identity of the user cannot be confirmed, and notifies the user of a processing error or requests the user to redo the processing (Step S108).

### 1-4. Modification

### 1-4-1. Verification Processing for Verifying That Duplication Terminal is Present Nearby

The processing according to the above embodiment may be accompanied by various modifications. For example, the management device 100 may perform duplication after confirming that the first device 10 and the second device 20 for use in duplication are terminals owned by the user without fail by verifying that the first device 10 and the second device 20 are nearby with higher accuracy.

Specifically, the management device 100 determines whether or not the first device 10 and the second device 20 are present nearby before duplication of the key information, and duplicates the key information stored in the first device 10 to the second device 20 when it is determined that the first device 10 and the second device 20 are present nearby.

For example, the management device 100 determines that the first device 10 and the second device 20 are present nearby on the basis of a degree of similarity of operation information detected by the sensors included in the first device 10 and the second device 20. More specifically, the management device 100 acquires the operation information (acceleration information or inertia information) when the user performs an operation such as an operation of shaking the first device 10 and the second device 20 while holding the first device 10 and the second device 20 being overlapped. Then, the management device 100 executes duplication of the key information only in a case where it is determined that the pieces of the operation information of the two devices have a sufficient degree of similarity therebetween.

Such processing enables the management device 100 to confirm that the first device 10 and the second device 20 are nearby and that both devices are owned by the user with higher accuracy as compared with search by communication. For example, in the operation of the control application, the management device 100 can perform the above confirmation by instructing the user to perform the above operation before starting the duplication processing. As a result, the management device 100 can prevent a third party that intercepts communication from illegally duplicating key information, and thus can perform duplication processing with higher safety.

In such a modification, each of the first device 10 and the second device 20 includes, in its own device, a sensor capable of detecting operation information, such as an acceleration sensor or an inertial sensor. Alternatively, the management device 100 may detect the operations of the first device 10 and the second device 20 on the basis of a moving image captured by an external camera or the like, and determine a degree of similarity of the operation information from the detected data. In addition, various known techniques may be used to determine the degree of similarity of the operation information.

### 1-4-2. Storage of Duplication Trace

In addition, after duplicating the key information to the second device 20, the management device 100 may record a trace regarding duplication on a tamper-proof network.

Specifically, the management device 100 records, as a trace, identifiers of the first device 10 and the second device 20 and date and time information about execution of duplication, and adds a signature by the key information to the recorded trace.

For example, as a transaction of a predetermined blockchain network which is an example of a tamper-proof network, the management device 100 registers a trace indicating that duplication has been executed in the blockchain. The management device 100 adds the duplication date and time, the identifiers of the first device 10 and the second device 20, and the signature by the secret key to the transaction.

As described above, by recording a trace regarding duplication on a tamper-proof network, the management device 100 can announce which key information has been duplicated to which device in a form that cannot be tampered. As a result, the service side can confirm that an access is not an unauthorized access even when the access has been performed by another terminal because unauthorized duplication has not been performed or the key information has been officially duplicated. In particular, in a case where the user authentication is a trigger for a transaction of encrypted assets using a blockchain, the service enables further enhancement of security of a transaction by obligating recording of a duplication trace in the blockchain.

### 1-4-3. Detection of Authentication Means

In the above embodiment, as an example, the description has been made of duplication of the key information between the first device 10 and the second device 20, which are the authenticators related to fingerprints and include the fingerprint authentication sensors as authentication terminals. However, even if a backup source and a backup destination are authenticators having different authentication means, the management device 100 can execute duplication by the management processing.

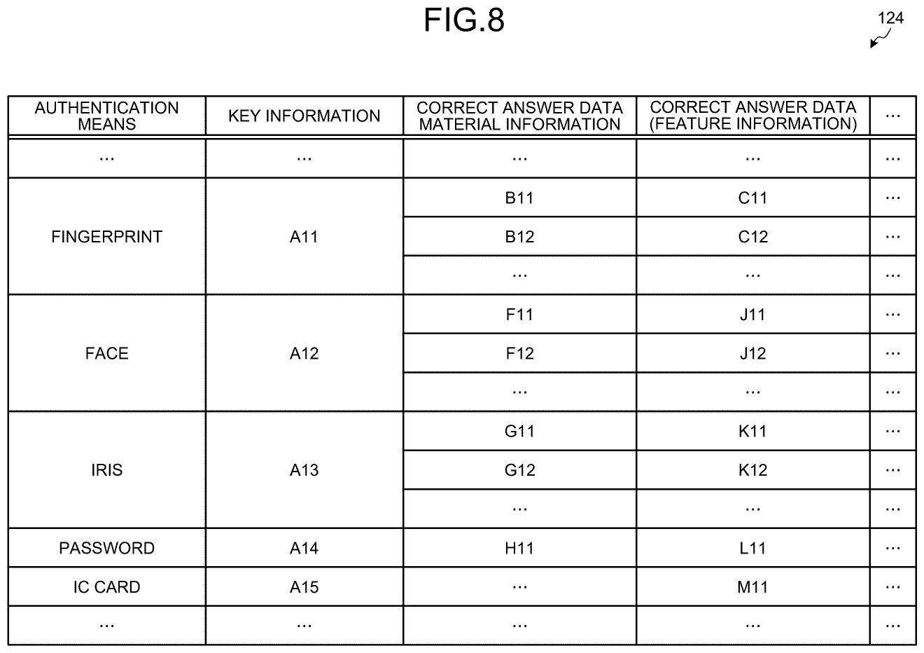

For example, it is assumed that the backup source (first device) is a smartphone or the like and is a terminal having a plurality of authenticators. In this case, the first device includes a plurality of authenticators. Such an example will be described with reference to FIG. 8.

FIG. 8 is a diagram illustrating an example of a data table 124 according to the modification. The data table 124 shows an example of the authentication information held in the first device which is the backup source terminal.

In the example illustrated in FIG. 8, the data table 124 has items such as “authentication means”, “key information”, “correct answer data material information”, and “correct answer data (feature information)”, similarly to the data table 122 illustrated in FIG. 4. Although in the example illustrated in FIG. 8, information stored in the item is conceptually shown as “A11”, specific information to be described later is stored in each item in practice.

FIG. 8 illustrates that the first device includes a plurality of means such as a fingerprint, a face, an iris, a password, and an IC card as the authentication means. This indicates that the first device has a plurality of sensors (camera, fingerprint sensor, input of character string information, non-contact communication function, etc.) and can authenticate a user by various means. In this case, the first device has correct answer data corresponding to each authentication means, and material information thereof. Note that the first device may have different key information for each authentication means, or may have key information common to a plurality of authentication means.

In this case, when acquiring two pieces of device information for the preparation of the duplication processing, the management device 100 grasps the authentication means included in the two devices. Specifically, the management device 100 determines whether or not an identity of the user can be authenticated by the authentication means common to the first device and the second device. Then, when determining that the authentication of the identity of the user is possible by the common authentication means, the management device 100 performs control to execute the authentication of the identity of the user in the first device using the common authentication means, and transfers authentication information regarding the common authentication means to the second device.

In other words, the management device 100 transfers the authentication information related to the authentication means common to the authentication means of the first device and the authentication means of the second device. For example, when both devices can perform fingerprint authentication as in the embodiment, the management device 100 transfers a fingerprint template (or an image for generating the fingerprint template) as the authentication information. Alternatively, in a case where both the devices are devices that can perform face authentication, the management device 100 transfers a face authentication template (or a face image for generating the face authentication template) as the authentication information. Note that in a case where there is a plurality of authentication means common to both the devices, the management device 100 may transfer authentication information related to a more accurate authentication means or may transfer authentication information according to a request of the user.

With the above processing, even if the user does not take authentication means between the devices into consideration, appropriate authentication information is transferred between the devices, and the duplication processing proceeds without any trouble.

Note that the management device 100 may perform control to transfer authentication information of other authentication means than that common to both the devices from the first device to the second device. For example, the management device 100 may transfer the face authentication template or the face image even when duplicating in the fingerprint authentication. In this case, the second device holds authentication information such as a face authentication template and a face image although not used for authentication. Such authentication information can be used when key information is further duplicated to a different device. Specifically, by causing the second device to hold such authentication information, the management device 100 can utilize the authentication information for duplication processing of a next generation, so that it is possible to save time and effort for the user to prepare new authentication information, thereby improving usability.

Note that as in the above-described modification, in a case where the first device or the second device is a high-performance terminal such as a smartphone, the first device or the second device itself may function as the management device 100. In other words, either the first device or the second device can be the same as the management device 100.

In addition, the authentication information described in the embodiment and the modification is an example, and the management device 100 may use any information as the authentication information as long as the information enables authentication of an identity of the user.

In addition, the forms of the first device and the second device described in the embodiment and the modification are merely examples, and not only a smartphone but also any form may be used as long as it is an information processing terminal capable of inputting arbitrary authentication information, such as a tablet terminal, a game controller, and a PC.

### 2. Other Embodiments

The processing according to each embodiment described above may be performed in various different forms other than each embodiment described above.

Among the processing described in the above embodiments, it is possible to manually perform all or a part of the processing described as being performed automatically, or it is possible to automatically perform, by a known method, all or a part of the processing described as being performed manually. Furthermore, the processing procedures, the specific names, and the information including various types of data and parameters illustrated in the above document and drawings can be arbitrarily changed unless otherwise specified. For example, the various types of information illustrated in the respective drawings are not limited to the illustrated information.

In addition, each component of each device illustrated in the drawings is functionally conceptual, and is not necessarily configured physically as illustrated in the drawings. Specifically, a specific form of distribution and integration of each device is not limited to the illustrated form, and all or a part thereof can be functionally or physically distributed and integrated on an arbitrary unit basis according to various loads, use conditions, and the like. For example, the transfer unit 134 and the duplication unit 135 may be integrated.

In addition, the above-described embodiment and modification can be appropriately combined within a range in which the processing contents do not contradict each other.

In addition, the effects described in the present specification are examples only and are not limited, and other effects may be provided.

### 3. Effects of Management Device According to Present Disclosure

As described in the foregoing, the management device according to the present disclosure (the management device 100 in the embodiment) includes the communication control unit (the communication control unit 133 in the embodiment), the transfer unit (the transfer unit 134 in the embodiment), and the duplication unit (the duplication unit 135 in the embodiment). The communication control unit sets up a session between the first device and the second device. Upon acquisition of the first authentication result indicating that the first device has executed the authentication of the identity of the user, the transfer unit transfers the authentication information used in the authentication processing in the first device to the second device. Upon acquisition of the second authentication result indicating that the second device has executed the authentication of the identity of the user using the transferred authentication information, the duplication unit duplicates the key information corresponding to the first authentication result and stored in the first device to the second device.

As described above, after setting up a secure session between the devices related to backup, the management device according to the present disclosure performs authentication using the same authentication information between the both devices, and duplicates the key information only when the authentication has succeeded. The user only performs authentication as usual, and does not need a special procedure. As a result, the management device performs duplication only between terminals that can be reliably confirmed to be used by a user himself/herself while performing simple authentication as usual, and thus, it is possible to easily and safely manage a key while maintaining security.

In addition, the transfer unit acquires, as the first authentication result, signature information that is a signature certifying that the authentication processing of the user has been executed by the first device and is a signature using key information.

As described above, the management device can enhance safety of duplication by using the first authentication result in a method of not allowing correct answer data itself to flow out to a network as employed in FIDO.

Further, the transfer unit transfers biological information of the user to the second device as the authentication information. For example, the transfer unit transfers, to the second device, feature information generated from at least one of fingerprint information, face information, vein information, iris information, voiceprint information, palm print information, handwriting information, and personal behavior information of the user as the biological information of the user. Specifically, upon acquisition of the first authentication result by collation of the fingerprint information of the user using the fingerprint sensor included in the first device, the transfer unit transfers the feature information of the fingerprint information of the user used in the collation in the first device to the second device. Upon acquisition of the second authentication result by collation in which transferred feature information is used as correct answer data and which is collation of the fingerprint information of the user using the fingerprint sensor included in the second device, the duplication unit duplicates the key information stored in the first device to the second device.

In this manner, the management device can easily complete authentication by using biological information of a user for authentication.

In addition, as the biological information of the user, the transfer unit transfers material information for generating feature information of at least one of the fingerprint information, the face information, the vein information, the iris information, the voiceprint information, the palm print information, the handwriting information, and the personal behavior information of the user to the second device.

In this manner, the management device may transfer the material information instead of the feature information itself. As a result, even when different authentication engines are operating in the first device and the second device and the same template cannot be used, the management device can proceed with the duplication processing according to the embodiment without any trouble by generating a new template from the material information.

In addition, as the authentication information, the transfer unit may transfer character string information registered in advance by the user for the authentication processing to the second device.

Thus, the management device may perform authentication with character string information such as a password, a PIN code, and a specific word. As a result, the management device can execute the duplication processing according to the embodiment even between devices not including a sensor for biometric authentication.

In addition, as the authentication information, the transfer unit may transfer, to the second device, an identifier of the third device (IC card or the like) or key information registered in advance by a user for the authentication processing, the third device being capable of non-contact communication.

Thus, the management device may authenticate the user with information indicating what the user has, in addition to authentication indicating what the user is (biometric authentication or the like) or what the user knows (password or the like). As a result, the management device can perform flexible person authentication according to a situation of the user.

After duplicating the key information to the second device, the duplication unit may cause the second device to execute authentication processing for certifying that the duplicated key information is available.

Thus, the management device can confirm that the duplication processing has been reliably performed by checking the use of the key information after the backup.

In addition, the duplication unit determines whether or not the first device and the second device are present nearby before duplication of the key information, and duplicates the key information stored in the first device to the second device when it is determined that the first device and the second device are present nearby. Specifically, the duplication unit determines that the first device and the second device are present nearby on the basis of a degree of similarity of operation information detected by the sensors included in the first device and the second device.

Thus, the management device may duplicate the key information after confirming that both terminals are surely nearby, for example, that both terminals are operating at the same acceleration. As a result, the management device can enhance safety of the duplication.

In addition, after duplicating the key information to the second device, the duplication unit may record a trace regarding the duplication on a tamper-proof network. For example, the duplication unit records, as a trace, the identifiers of the first device and the second device and date and time information about execution of duplication, and adds a signature by key information to the recorded trace.

Thus, the management device can clearly indicate that duplication has been reliably performed and indicate a duplication destination by registering a duplication trace in a tamper-proof network such as a blockchain.

In addition, in the management system according to the embodiment, either the first device or the second device may be the same as the management device.

As described above, since the backup source terminal and the backup destination terminal function as the management device, the user can execute the duplication processing according to the embodiment with a simple system without requiring a large number of terminals.

Further, when authentication means common to the first device and the second device determines whether or not the authentication of the identity of the user is possible, and the common authentication means determines that the authentication of the identity of the user is possible, the transfer unit performs control to execute the authentication of the identity of the user by the first device using the common authentication means, and transfers the authentication information regarding the common authentication means to the second device.

As described in the foregoing, the management device automatically transfers the authentication information corresponding to the authentication means of the backup destination and the backup source, so that the user can quickly duplicate the key information without time and effort for the user to check what authentication means is present in the terminal or to select one of a plurality of pieces of authentication information.

### 4. Hardware Configuration

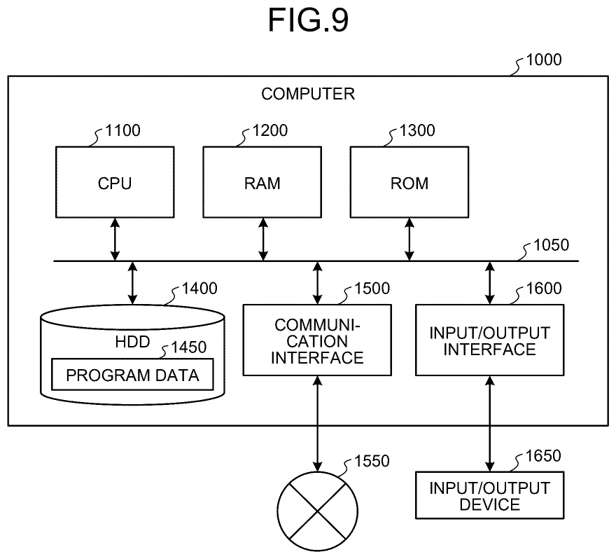

The information devices such as the management device 100 and the first device 10 according to the embodiments described above are realized by a computer 1000 having such a configuration as illustrated in FIG. 9, for example. In the following, description will be made of the management device 100 as an example. FIG. 9 is a hardware configuration diagram illustrating an example of the computer 1000 that implements functions of the management device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or in the HDD 1400 into the RAM 1200, and executes processing corresponding to various programs.

The ROM 1300 stores a boot program such as a basic input output system (BIOS) executed by the CPU 1100 when the computer 1000 is activated, a program depending on the hardware of the computer 1000, and the like.

The HDD 1400 is a computer-readable recording medium that non-transiently records a program executed by the CPU 1100, data for use by the program, and the like. Specifically, the HDD 1400 is a recording medium that records a management program according to the present disclosure as an example of program data 1450.

The communication interface 1500 is an interface for the computer 1000 to connect to an external network 1550 (e.g., the Internet). For example, the CPU 1100 receives data from other apparatus or transmits data generated by the CPU 1100 to other apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, an edge, or a printer via the input/output interface 1600. In addition, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the management device 100 according to the embodiment, the CPU 1100 of the computer 1000 implements the functions of the control unit 130 and the like by executing the management program loaded on the RAM 1200. In addition, the HDD 1400 stores the management program according to the present disclosure and data in the storage unit 120. Note that although the CPU 1100 reads the program data 1450 from the HDD 1400 and executes the program data, as another example, the programs may be acquired from other device via the external network 1550.

Note that the present technique can also have the following configurations.
(1) A management device comprising:
   a communication control unit that sets up a session between a first device and a second device;
   a transfer unit that, upon acquisition of a first authentication result indicating that authentication of an identity of a user has been executed by the first device, transfers, to the second device, authentication information used in authentication processing in the first device; and
   a duplication unit that, upon acquisition of a second authentication result indicating that authentication of the identity of the user has been executed by the second device using the transferred authentication information, duplicates key information corresponding to the first authentication result and stored in the first device to the second device.
(2) The management device according to (1), wherein
   the transfer unit
   acquires, as the first authentication result, signature information that is a signature certifying that the authentication processing of the user has been executed by the first device and is a signature using the key information.
(3) The management device according to (2), wherein
   the transfer unit
   transfers biological information of the user to the second device as the authentication information.
(4) The management device according to (3), wherein
   the transfer unit
   transfers, to the second device, feature information generated from at least one of fingerprint information, face information, vein information, iris information, voiceprint information, palm print information, handwriting information, and personal behavior information of the user as the biological information of the user.
(5) The management device according to (3) or (4), wherein
   the transfer unit
   transfers, to the second device, material information for generating feature information of at least one of fingerprint information, face information, vein information, iris information, voiceprint information, palm print information, handwriting information, and personal behavior information of the user as the biological information of the user.
(6) The management device according to any one of (2) to (5), wherein
   the transfer unit
   transfers, to the second device, character string information registered in advance by the user for the authentication processing as the authentication information.
(7) The management device according to any one of (2) to (6), wherein
   as the authentication information, the transfer unit
   transfers, to the second device, an identifier of a third device registered in advance by the user for the authentication processing, the third device being capable of performing non-contact communication.
(8) The management device according to any one of (1) to (7), wherein
   after duplicating the key information to the second device, the duplication unit
   causes the second device to execute authentication processing for certifying that the duplicated key information is available.
(9) The management device according to any one of (1) to (8), wherein
   the duplication unit
   determines whether or not the first device and the second device are present nearby before duplication of the key information, and duplicates the key information stored in the first device to the second device when it is determined that the first device and the second device are present nearby.
(10) The management device according to (9), wherein
   the duplication unit
   determines that the first device and the second device are present nearby on the basis of a degree of similarity of operation information detected by sensors included in the first device and the second device.
(11) The management device according to any one of (1) to (10), wherein
   after duplicating the key information to the second device, the duplication unit
   records a trace regarding duplication on a tamper-proof network.
(12) The management device according to (11), wherein
   the duplication unit
   records, as the trace, identifiers of the first device and the second device and date and time information about execution of duplication, and adds a signature based on the key information to the recorded trace.
(13) The management device according to (3), wherein
   upon acquisition of the first authentication result by collation of fingerprint information of the user using a fingerprint sensor included in the first device, the transfer unit
   transfers, to the second device, feature information of the fingerprint information of the user used in the collation in the first device, and
   upon acquisition of the second authentication result by collation of fingerprint information of the user using a fingerprint sensor included in the second device, the collation using the transferred feature information as correct answer data, the duplication unit
   duplicates the key information stored in the first device to the second device.
(14) The management device according to any one of (1) to (13), wherein
   either the first device or the second device is the same as the management device.
(15) The management device according to any one of (1) to (14), wherein
   when authentication means common to the first device and the second device determines whether or not the authentication of the identity of the user is possible, and the common authentication means determines that the authentication of the identity of the user is possible, the transfer unit
   performs control to execute the authentication of the identity of the user by the first device using the common authentication means, and transfers the authentication information regarding the common authentication means to the second device.
(16) A management method comprising:
   setting up, by a computer, a session between a first device and a second device;
   upon acquisition of a first authentication result indicating that authentication of an identity of a user has been executed by the first device, transferring, by the computer, to the second device, authentication information used in authentication processing in the first device; and
   upon acquisition of a second authentication result indicating that the authentication of the identity of the user has been executed by the second device using the transferred authentication information, duplicating, by the computer, key information corresponding to the first authentication result and stored in the first device to the second device.
(17) A management program that causes a computer to function as:
   a communication control unit that sets up a session between a first device and a second device;
   a transfer unit that, upon acquisition of a first authentication result indicating that authentication of an identity of a user has been executed by the first device, transfers, to the second device, authentication information used in authentication processing in the first device; and
   a duplication unit that, upon acquisition of a second authentication result indicating that the authentication of the identity of the user has been executed by the second device using the transferred authentication information, duplicates key information corresponding to the first authentication result and stored in the first device to the second device.

### Reference Signs List

1 MANAGEMENT SYSTEM
10 FIRST DEVICE
20 SECOND DEVICE
50 USER
100 MANAGEMENT DEVICE
110 COMMUNICATION UNIT
120 STORAGE UNIT
130 CONTROL UNIT
131 RECEPTION UNIT
132 ACQUISITION UNIT
133 COMMUNICATION CONTROL UNIT
134 TRANSFER UNIT
135 DUPLICATION UNIT

1. A management device comprising:
a communication control unit that sets up a session between a first device and a second device;
a transfer unit that, upon acquisition of a first authentication result indicating that authentication of an identity of a user has been executed by the first device, transfers, to the second device, authentication information used in authentication processing in the first device; and
a duplication unit that, upon acquisition of a second authentication result indicating that authentication of the identity of the user has been executed by the second device using the transferred authentication information, duplicates key information corresponding to the first authentication result and stored in the first device to the second device.

2. The management device according to claim 1, wherein
the transfer unit
acquires, as the first authentication result, signature information that is a signature certifying that the authentication processing of the user has been executed by the first device and is a signature using the key information.

3. The management device according to claim 2, wherein
the transfer unit
transfers biological information of the user to the second device as the authentication information.

4. The management device according to claim 3, wherein
the transfer unit
transfers, to the second device, feature information generated from at least one of fingerprint information, face information, vein information, iris information, voiceprint information, palm print information, handwriting information, and personal behavior information of the user as the biological information of the user.

5. The management device according to claim 3, wherein
the transfer unit
transfers, to the second device, material information for generating feature information of at least one of fingerprint information, face information, vein information, iris information, voiceprint information, palm print information, handwriting information, and personal behavior information of the user as the biological information of the user.

6. The management device according to claim 2, wherein
the transfer unit
transfers, to the second device, character string information registered in advance by the user for the authentication processing as the authentication information.

7. The management device according to claim 2, wherein
as the authentication information, the transfer unit
transfers, to the second device, an identifier of a third device registered in advance by the user for the authentication processing, the third device being capable of performing non-contact communication.

8. The management device according to claim 1, wherein
after duplicating the key information to the second device, the duplication unit
causes the second device to execute authentication processing for certifying that the duplicated key information is available.

9. The management device according to claim 1, wherein
the duplication unit
determines whether or not the first device and the second device are present nearby before duplication of the key information, and duplicates the key information stored in the first device to the second device when it is determined that the first device and the second device are present nearby.

10. The management device according to claim 9, wherein
the duplication unit
determines that the first device and the second device are present nearby on the basis of a degree of similarity of operation information detected by sensors included in the first device and the second device.

11. The management device according to claim 1, wherein
after duplicating the key information to the second device, the duplication unit
records a trace regarding duplication on a tamper-proof network.

12. The management device according to claim 11, wherein
the duplication unit
records, as the trace, identifiers of the first device and the second device and date and time information about execution of duplication, and adds a signature based on the key information to the recorded trace.

13. The management device according to claim 3, wherein
upon acquisition of the first authentication result by collation of fingerprint information of the user using a fingerprint sensor included in the first device, the transfer unit
transfers, to the second device, feature information of the fingerprint information of the user used in the collation in the first device, and
upon acquisition of the second authentication result by collation of fingerprint information of the user using a fingerprint sensor included in the second device, the collation using the transferred feature information as correct answer data, the duplication unit
duplicates the key information stored in the first device to the second device.

14. The management device according to claim 1, wherein
either the first device or the second device is the same as the management device.

15. The management device according to claim 1, wherein
when authentication means common to the first device and the second device determines whether or not the authentication of the identity of the user is possible, and the common authentication means determines that the authentication of the identity of the user is possible, the transfer unit
performs control to execute the authentication of the identity of the user by the first device using the common authentication means, and transfers the authentication information regarding the common authentication means to the second device.

16. A management method comprising:
setting up, by a computer, a session between a first device and a second device;
upon acquisition of a first authentication result indicating that authentication of an identity of a user has been executed by the first device, transferring, by the computer, to the second device, authentication information used in authentication processing in the first device; and
upon acquisition of a second authentication result indicating that the authentication of the identity of the user has been executed by the second device using the transferred authentication information, duplicating, by the computer, key information corresponding to the first authentication result and stored in the first device to the second device.

17. A management program that causes a computer to function as:
a communication control unit that sets up a session between a first device and a second device;
a transfer unit that, upon acquisition of a first authentication result indicating that authentication of an identity of a user has been executed by the first device, transfers, to the second device, authentication information used in authentication processing in the first device; and
a duplication unit that, upon acquisition of a second authentication result indicating that the authentication of the identity of the user has been executed by the second device using the transferred authentication information, duplicates key information corresponding to the first authentication result and stored in the first device to the second device.
